(19) United States
(12) Patent Application Publication
(10) Pub. No.: US 2003/0179668 A1
(43) Pub. Date: Sep. 25, 2003

(54) Information recording apparatus, information recording method, information recording program and information recording medium

(75) Inventors: Takao Sawabe, Tokorozawa-shi (JP); Masanori Nakahara, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: Pioneer Coporation

(21) Appl. No.: 10/338,895

(22) Filed: Jan. 9, 2003

(30) Foreign Application Priority Data
Jan. 10, 2002 (JP) P2002-3524

(51) Int. Cl. G11B 7/00

(52) U.S. Cl. 369/47.13; 369/59.25

(57) ABSTRACT

An information recording apparatus encodes distributed information which is music information to be recorded distributed via a network in a specific encoding scheme for allowing decode by a plurality of types of information reproducing apparatuses, records the encoded music information and also records the distributed information as-is in a distribution method thereof, and further records address information indicating a position having the encoded music information recorded and address information indicating a position having the distributed information recorded as-is in the distribution method recorded. And when the distributed information is moved to the outside after being recorded, it deletes the address information corresponding to the moved distributed information.

### BACKGROUND OF THE INVENTION

1. Field of the Invention

The present invention relates to a technological field of an information recording apparatus, an information recording method, an information recording program and an information recording medium, and in particular, to the technological field of the information recording apparatus and information recording method for recording record information such as music information or image information distributed via a network such as the Internet on a recording medium such as an optical disk, a magnetic disk or a semiconductor memory, and the information recording program for implementing the recording process and the information recording medium having recorded the information recording program.

2. Description of the Related Art

In recent years, research and development has been underway on recording formats for recording audio information including music information and voice information on recording mediums such as a DVD (Digital Versatile Disc).

On the other hand, so-called music distribution (commonly referred to as EMD: Electronics Music Distribution) is being started recently for distributing the above audio information via a network such as the Internet to personal computers for individual use, for example. Thus, it is desirable that the above recording format currently under development also conforms to this music distribution method.

Now, in the current music distribution there are several distribution methods (that is compression techniques used in the distribution) incompatible with each other such as the AC-3 (Audio Compression-3) method or the MP3 (MPEG (Moving Picture Expert Group) 1 Audio Layer 3) method.

On the other hand, the music information distributed by the above music distribution is generally protected by so-called copyright law, and so it is necessary to effectively prevent the distributed music information from being freely copied without permission of the copyright holder.

However, in the case of the above-mentioned music distribution methods in the past, if the music information distributed by each of the methods is to be recorded as-is on the recording medium such as the DVD, there exist on one recording medium a mixture of several types of music information compressed by different compression techniques. Consequently, in the cases of reproducing the music information recorded on the recording medium, one information reproducing apparatus must conform to the types of compression technique.

Therefore, in this case, there were a problem of unsecured “compatibility in reproduction process”, and a problem that attempting to conform the compression techniques with each other in the information reproducing apparatus increases manufacturing costs extremely.

This problem leads to another problem that the increased manufacturing costs of the information reproducing apparatus lead to the soaring of the total manufacturing costs of the information recording/reproducing system including the information reproducing apparatus and an information recording apparatus for recording the music information on the recording medium, thereby preventing the information recording/reproducing system from being widely used.

Another problem is that, in the case where the distributed music information is transferred from a distribution destination thereof to a next recording medium, if music information that remains on the recording medium at the distribution destination instead of having moved away therefrom can be reproduced therefrom, multiple pieces of the same music information are generated from the distribution destination without permission of the copyright holder and the effective protection of the copyright on the music information cannot be implemented.

### SUMMARY OF THE INVENTION

Thus, the present invention has been made in the light of the above problems, and its object is to provide the information recording apparatus and information recording method capable of recording the music information on the recording medium in such a way as to reduce the costs of the information reproducing apparatus and consequently reduce the costs of the information recording/reproducing system so as to promote the wide use thereof and also capable of providing effective copyright-related management of the distributed music information, and the information recording program for implementing the recording process and the information recording medium having recorded the information recording program.

The above object of the present invention can be achieved by an information recording apparatus of the present invention. The apparatus is provided with: an encoding device which encodes record information in a specific encoding scheme for allowing decode by a plurality of types of information reproducing apparatuses to generate encoded record information; a first recording device which records the generated encoded record information on a recording medium; a second recording device which records the record information as-is in an original encoding scheme thereof on the recording medium; an address information recording device which records record address information including first address information indicating a position on the recording medium where the generated encoded record information is recorded and second address information indicating a position on the recording medium where the record information is recorded as-is in the original encoding scheme thereof; and a deleting device which, at least when the record information recorded as-is in the original encoding scheme thereof is determined to be undetectable on the recording medium, deletes from the recording medium the record address information corresponding to the record information determined to be undetectable.

According to the present invention, as the record information is encoded by a specific encoding method, it can be recorded in a state capable of decoding and reproduction by a plurality of types of information reproducing apparatuses so that the compatibility in the reproduction process can be secured.

Therefore, it is possible to reduce the costs of the information reproducing apparatus by cutting the costs arising when applying it as the information reproducing apparatus to a plurality of types of encoding methods and consequently reduce the costs of the information recording/reproducing system including the information reproducing apparatus and the information recording apparatus of the present invention so as to promote diffusion thereof.

In addition, when the record information recorded as-is by the original encoding method is determined as undetectable on the recording medium, the record address information corresponding to the record information determined to be undetectable is deleted on the recording medium, and so even if an illegal attempt is made to render detectable by an operation after the deletion the record information determined to be undetectable, the illegal operation can be rendered infeasible since both the first address information and the second address information have disappeared.

In one aspect of the present invention, the record information is determined to be undetectable on the recording medium in the case where a process of deleting the record information from the recording medium is performed or a process of moving the record information from the recording medium to the outside is performed.

According to this aspect, the address information is deleted after the record information is deleted or moved, and it is thus possible to securely prevent the record information from being illegally restored on the recording medium after being deleted or moved.

In another aspect of the present invention, in the case where the record information is one other than record information distributed via a network, the address information recording device records invalidity information, indicating that the second address information is invalid, at the position on the recording medium at which the second address information should be recorded.

According to this aspect, when recording the record information other than the distributed record information on the recording medium, invalidity information indicating that the second address information is invalid is recorded on the position on the recording medium at which the second address information should be recorded, and it is thus possible to record the record information other than the distributed record information while maintaining the compatibility on the recording format with the case of recording the distributed record information.

In further aspect of the present invention, the record information is distributed via a network in compliance with the SDMI (Secure Digital Music Initiative) specifications.

According to this aspect, it is possible to implement the recording process and so on as to the record information while observing the rules for deleting or moving the record information stipulated in the SDMI specifications.

The above object of the present invention can be achieved by an information recording method of the present invention. The method is provided with: an encoding process of encoding record information in a specific encoding scheme for allowing decode by a plurality of types of information reproducing apparatuses to generate encoded record information; a first recording process of recording the generated encoded record information on a recording medium; a second recording process of recording the record information as-is in an original encoding scheme thereof on the recording medium; an address information recording process of recording record address information including first address information indicating a position on the recording medium where the generated encoded record information is recorded and second address information indicating a position on the recording medium where the record information is recorded as-is in the original encoding scheme thereof; and a deleting process of, at least when the record information recorded as-is in the original encoding scheme thereof is determined to be undetectable from the recording medium, deletes from the recording medium the record address information corresponding to the information determined to be undetectable.

According to the present invention, as the record information is encoded by a specific encoding method, it can be recorded in a state capable of decoding and reproduction by a plurality of types of information reproducing apparatuses so that the compatibility in the reproduction process can be secured.

In addition, when the record information recorded as-is by the original encoding method is determined as undetectable on the recording medium, the record address information corresponding to the record information determined to be undetectable is deleted on the recording medium, and so even if an illegal attempt is made to render detectable by an operation after the deletion the record information determined to be undetectable, the illegal operation can be rendered infeasible since both the first address information and the second address information have disappeared.

### BRIEF DESCRIPTION OF THE DRAWINGS

FIG. 1 is a block diagram showing an overview configuration of an information recording apparatus related to embodiments;

FIG. 2 is a flowchart showing a data recording process;

FIG. 3 is a diagram showing a physical format on an optical disk;

FIG. 4A is a diagram illustrating an idea of the data recording process (No. 1);

FIG. 4B is a diagram illustrating an idea of the data recording process (No. 2);

FIG. 4C is a diagram illustrating an idea of the data recording process (No. 3);

FIG. 5 is a diagram showing the configuration of control information; and

FIG. 6 is a flowchart showing a data moving process.

### DETAILED DESCRIPTION OF THE PREFERRED EMBODUIMENTS

Next, preferred embodiments of the present invention will be described based on the drawings.

Moreover, the embodiments described below are the embodiments in the case of applying the present invention to an information recording apparatus for recording music information distributed by the above EMD on an optical disk as a recording medium capable of recording it.

(I) SDMI Specifications

First, before describing specific embodiments, a brief description will be given as to the SDMI specifications which the information recording apparatus related to the embodiments conforms to and are currently being laid down in order to protect productions such as the music information from illegal copying and so on.

The SDMI specifications are currently being laid down as the specifications which the information recording apparatus for recording the productions on the recording medium should conform to in order to protect the productions including the music information from illegal copying and so on, and are currently being laid down centering on the music industry of the U.S.A. And at the present stage, the specifications reportedly include the prescriptions that, for instance, when normally distributing and recording the music information from a distribution source to a personal computer and so on by the EMD, only reproduction by the personal computer (hereafter, a primary receiving source) which is a distribution destination is permitted, and in addition, when moving the production (not a copy) from the above primary receiving source to another portable reproducing apparatus or the like (hereafter, a secondary receiving source), the number of times of reproduction at the secondary receiving source is limited, or the music information distributed by the EMD has copyright information embedded therein by so-called electronic watermark technology.

Here, according to the SDMI specifications, in the case where the music information is distributed by using the EMD, the music information to be distributed only exists on the primary receiving source having received it instead of being copied from the distribution source to the primary receiving source (that is, distributing the music information to the primary receiving source while having it remaining at the distribution source). And also in the case of moving the music information from the primary receiving source to the above secondary receiving source, the music information no longer exists on the primary receiving source on completion of the moving, but it only exists on the secondary receiving source which is the moving destination.

Furthermore, when it is no longer necessary to have the music information heard at the secondary receiving source, it is possible to return the music information to the original primary receiving source. At this time, the music information has disappeared from the secondary receiving source after the return.

Thus, according to the SDMI specifications, an attempt is made, about the music information itself, to securely protect the music information as the production by permitting only the moving rather than copying thereof.

Moreover, according to the above-mentioned SDMI specifications, distributing the music information from the primary receiving source to the secondary receiving source is called a check out, and returning it from the secondary receiving source to the primary receiving source is called a check in. To be more specific, the check out and check in are intended to prescribe a bi-directional moving method of a limited type performed without fail between a certain primary receiving source and a secondary receiving source, and in this case, it is of course possible to specify various types of reproducing apparatuses as the secondary receiving source. Furthermore, it is also possible to operate a moving destination frequency setting function for allowing bidirectional limited moving from the primary receiving source to a plurality of secondary receiving sources at the same time (in this case, the frequency is a parameter set by the distribution source).

Moreover, the SDMI specifications also prescribe a relatively simple moving method called “Move” for performing a move which is not mere copying in a single direction between the primary receiving source and the secondary receiving source and different from the moving method of the music information by the above check out and check in. In this case, however, there may be an instance where there is no compensation for return or storage of the music information to the primary receiving source. In addition, the music information at the moving source disappears as with the above check out and check in.

(II) Embodiments

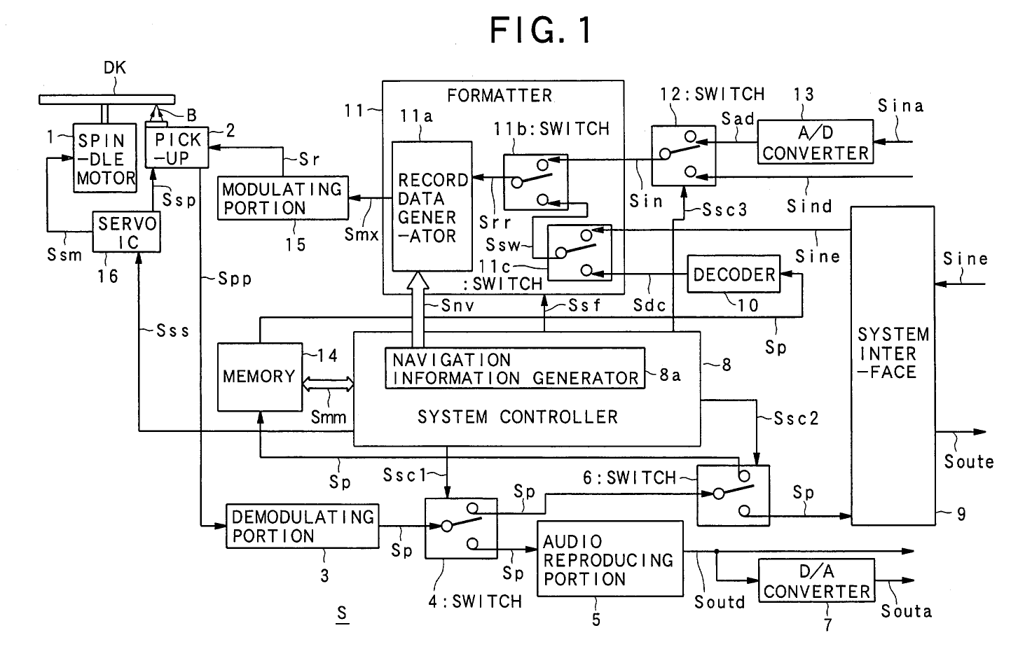

Next, the information recording apparatus related to the embodiments conforming to the above-mentioned SDMI specifications will be described by using FIGS. 1 to 6.

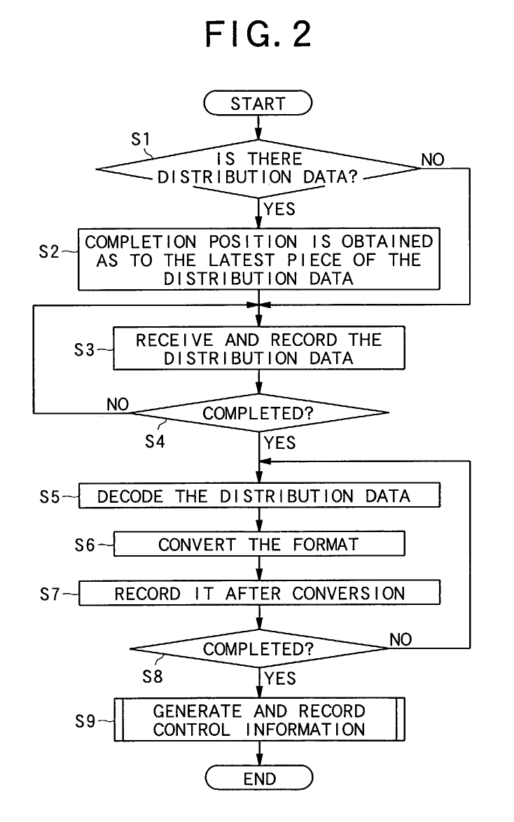

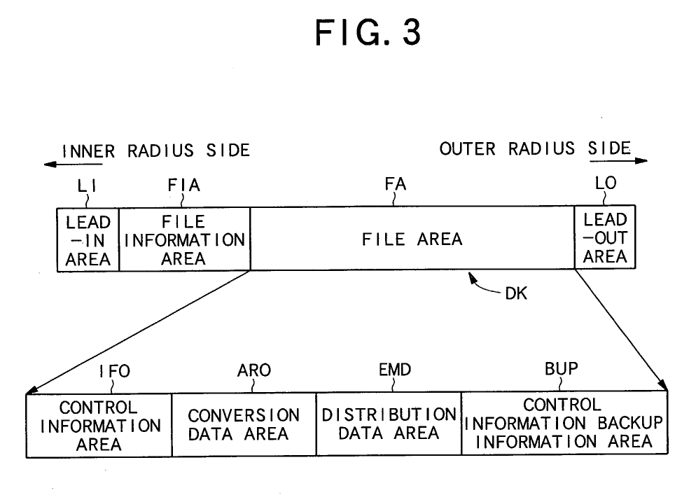

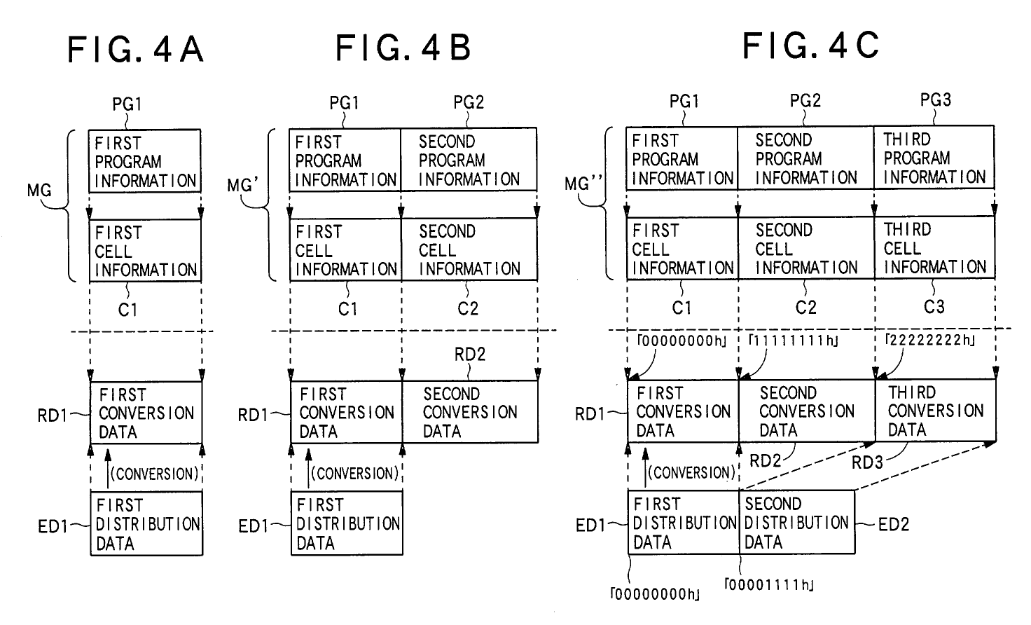

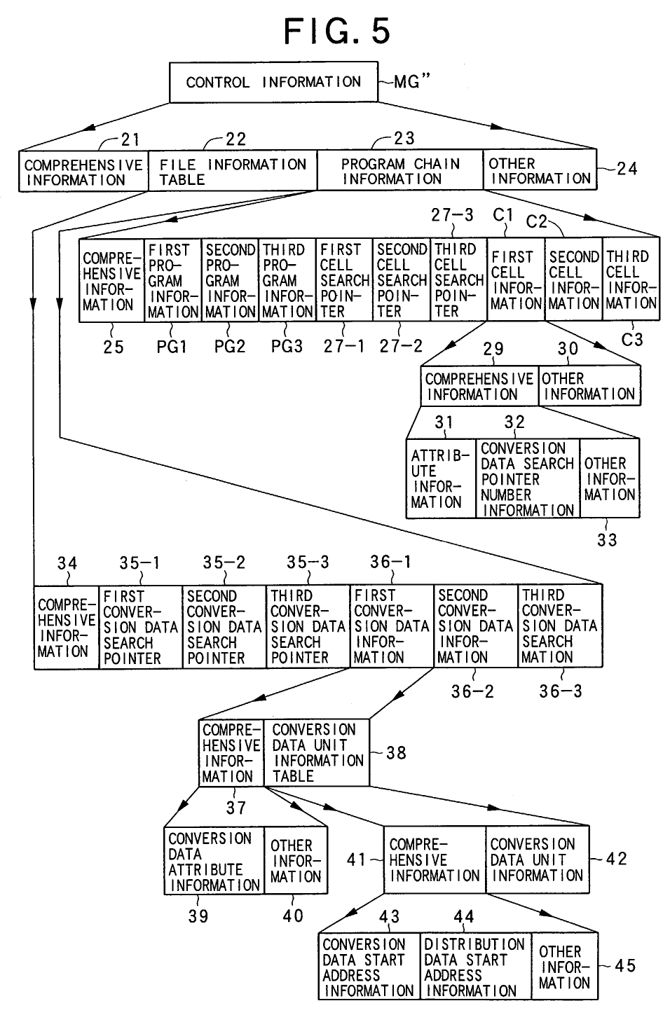

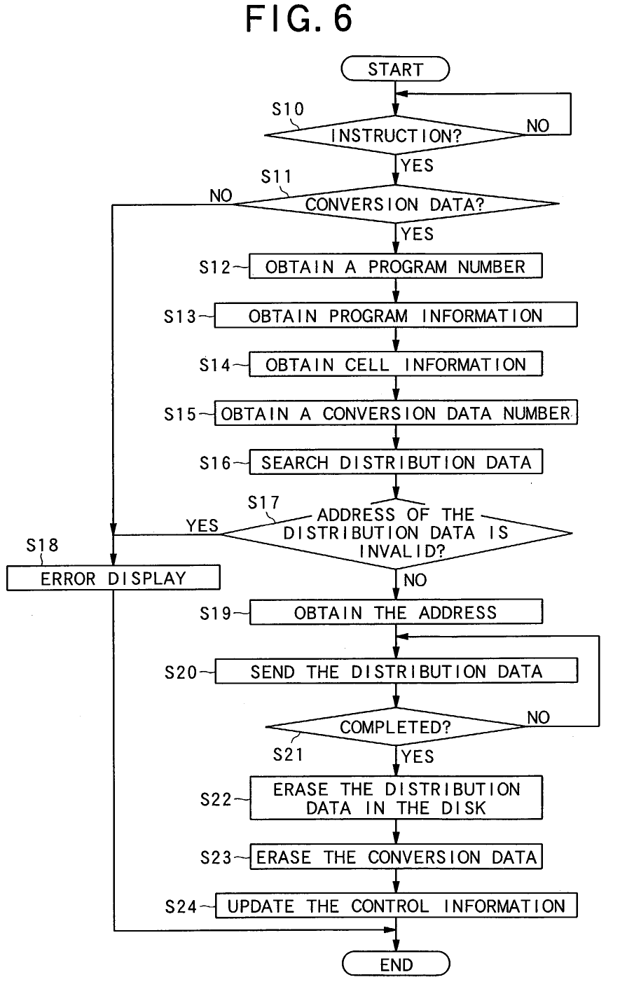

Moreover, FIG. 1 is a block diagram showing an overview configuration of the information recording apparatus related to the embodiments, FIG. 2 is a flowchart showing a data recording process implemented by this information recording apparatus, FIG. 3 is a diagram showing a physical format on the optical disk after the data recording process of the embodiments is implemented, FIG. 4 is a diagram illustrating an idea of the data recording process, FIG. 5 is a diagram showing the configuration (hierarchy) of control information mentioned later, and FIG. 6 is a flowchart showing a data moving process implemented by this information recording apparatus.

The information recording apparatus related to the embodiments has a function of recording on the optical disk the information distributed from a distribution server by the above-mentioned EMD. In addition, this information recording apparatus also has a function of recording on the optical disk the music information inputted from the outside via an input terminal not shown and also outputting the recorded music information to an external apparatus such as a speaker via an output terminal not shown.

To be more specific, as shown in FIG. 1, an information recording apparatus S related to the embodiments is comprised of a spindle motor 1, a pickup 2 as a first recording device, second recording device and an address information recording device, a demodulating portion 3, switches 4, 6 and 12, an audio reproducing portion 5, a D/A (Digital/Analog) converter 7, a system controller 8 as a deleting device, a system interface 9, a decoder 10 as an encoding device, a formatter 11, an A/D (Analog/Digital) converter 13, a memory 14, a modulating portion 15 and a servo IC (Integrated Circuit) 16.

In addition, the formatter 11 is comprised of switches 11b and 11c and a record data generator 11a.

Furthermore, the system controller 8 includes a navigation information generator 8a.

Next, the operation will be described.

(A) Embodiment of Recording Operation from an External Sound Source

First, a description will be given as to the operation in the case of recording on an optical disk DK capable of recording the music information outputted from an external sound source (to be more specific, an optical disk player for instance) other than the distribution server of EMD.

Moreover, in this case, the switch 11b in the formatter 11 is switched to the switch 12 side based on a control signal Ssf from the system controller 8.

First, in the case where the music information inputted from the external sound source via the input terminal not shown is music information Sina which is an analog signal, the music information Sina is inputted to the A/D converter 13, and is digitized by the A/D converter 13 and then is outputted as digital music information Sad to one of the input terminals of the switch 12.

On the other hand, in the case where the music information from the external sound source is music information Sind which is originally a digital signal, the music information Sind is outputted as-is to the other input terminal of the switch 12.

And the switch 12 selects either the above digital music information Sad or music information Sind as the music information to be recorded on the optical disk DK based on a control signal Ssc3 from the system controller 8, and outputs it to one of the input terminals of the switch 11b as input music information Sin.

Thus, from the switch 11b switched to the switch 12 side, the input music information Sin is outputted as music information Srr to the record data generator 11a.

On the other hand, the navigation information generator 8a in the system controller 8 generates control information (it may be generally called navigation information), based on the contents of the above music information Sina or Sind inputted from the above external sound source, for controlling reproduction aspects (order of reproduction, music information to be reproduced, etc.) when reproducing either one of the music information after recording it on the optical disk DK so as to conform to the format mentioned later, and outputs it as control information Snv to the record data generator 11a.

To describe the above control information in detail here, it shows the reproduction aspects on reproducing the music information. To be more specific, it divides corresponding music information into pieces of partial information called programs, and further divides one program into information units called cells so as to control the reproduction aspects thereof. That is to say, the control information corresponding to one piece of music information includes the information describing the order of reproduction for each cell, regarding the cell included in the music information as a minimum unit. And the information describing the order of reproduction includes the information describing the address information indicating a recording position on the optical disk DK having each cell recorded in the order corresponding to the order of reproduction of the cells. In other words, the control information corresponding to one piece of music information includes logical information (may be called a logical format) describing the order of reproduction of the cells included as the physical format in each program in each piece of the music information.

Next, the record data generator 11a superposes the above music information Srr and control information Snv to conform to the format mentioned later, and outputs it as superposition information Smx to the modulating portion 15.

Thus, the modulating portion 15 generates a record signal Sr for recording superposition information Smx on the optical disk DK by modulating the intensity of a light beam B for recording radiated from the pickup 2 based on the superposition information Smx, and outputs it to an unshown semiconductor laser driving portion for driving an unshown semiconductor laser in the pickup 2.

Thereafter, the semiconductor laser driving portion radiates the light beam B by driving the semiconductor laser to modulate the intensity of the light beam B according to the contents of the record signal Sr. And the light beam B is radiated to an information recording face in the optical disk DK while the intensity thereof is modulated so that a recording pit changing its shape according to the contents of the record signal Sr is formed in the information recording face, and the music information Sina or Sind is thereby recorded on the optical disk DK.

In this case, the horizontal and vertical positions of the light beam B radiated to the information recording face are based on a control signal Ssp from a servo IC 16, and the vertical radiated position (that is, a condensed position of the light beam B) is controlled by driving of an unshown focus actuator in the pickup 2. On the other hand, the horizontal radiated position is controlled by driving of an unshown tracking actuator in the pickup 2.

Furthermore, the spindle motor 1 controls revolutions of the optical disk DK to have the preset number of revolutions based on a control signal Ssm from the servo IC 16.

And for these purposes, the servo IC 16 generates and outputs the control signals Ssm and Ssp based on a control signal Sss from the system controller 8 respectively.

(B) Embodiment of Reproduction Output Operation to the Outside

Next, a description will be given as to the operation in the case of reproducing the music information recorded on the optical disk DK by the operation described in the above section (A) and outputting it to an external speaker and so on.

Moreover, in this case, the switch 4 is switched to the audio reproducing portion 5 side based on a control signal Ssc1 from the system controller 8.

First, on the reproduction process, the spindle motor 1 controls the revolutions of the optical disk DK to have the preset number of revolutions based on the control signal Ssm from the servo IC 16.

And the light beam B of a fixed intensity for reproduction is radiated to the information recording face of the optical disk DK from the unshown semiconductor laser in the pickup 2. In this case, the vertical and horizontal positions of the light beam B radiated to the information recording face are controlled by driving of the unshown focus actuator and tracking actuator in the pickup 2 based on the control signal Ssp from the servo IC 16 as with recording of the information.

Furthermore, for these purposes, the servo IC 16 generates and outputs the above control signals Ssm and Ssp based on the control signal Sss from the system controller 8 respectively.

Moreover, as to the position on the optical disk DK from which the information is to be reproduced, the recording position of the music information to be reproduced on the optical disk DK is obtained based on the contents of the control information recorded together with the music information by the above-mentioned recording process, and based on this, the position on the optical disk DK at which the music information to be reproduced is recorded is identified.

Next, the light beam B radiated to the information recording face is modulated by the recording pit formed on the information recording face, and reflected light thereof is received by an unshown photo-detector in the pickup 2. And a detection signal Spp for changing according to variation of the intensity of the reflected light received by the photo-detector is generated and outputted to the demodulating portion 3.

Thereafter, the demodulating portion 3 performs a preset demodulation process to the detection signal Spp and generates a demodulation signal Sp, and outputs it to the audio reproducing portion 5 via the switch 4 switched to the audio reproducing portion 5 side.

Thus, the audio reproducing portion 5 performs the preset reproduction process to the demodulation signal Sp to and generates a reproduction signal Soutd as a digital signal, and outputs it as-is to the external speaker and so on via an unshown digital output terminal and also outputs it to the D/A converter 7.

And the D/A converter 7 renders the reproduction signal Soutd analog, and outputs it as an analog reproduction signal Souta to the external speaker and so on via an unshown analog output terminal.

(C) Embodiment of Music Information Recording Operation by the EMD

Next, a description will be given as to the music information recording operation related to the present invention for recording the music information distributed from the distribution server in the EMD.

Moreover, in this case, the switches 11b and 11c in the formatter 11 are switched to the switch 11c side and the system interface 9 side based on the control signal Ssf from the system controller 8. In addition, the switch 4 is switched to the switch 6 side based on the control signal Ssc1 from the system controller 8, and furthermore, the switch 6 is switched to the memory 14 side based on a control signal Ssc from the system controller 8.

First, music information Sine inputted from the distribution server via an input terminal not shown has a preset interface process performed thereto by the system interface 9, and is outputted thereafter to one of the input terminals of the switch 11c.

And the switch 11c switched to the system interface 9 side outputs the music information Sine as-is as the music information Ssw to the other input terminal of the switch 11b.

Thus, the switch 11b switched to the switch 11c side outputs the music information Ssw as-is as the music information Srr to the record data generator 11a.

And the record data generator 11a performs no process to the music information Srr, and outputs it as the superposition information Smx to the modulating portion 15.

Thus, the modulating portion 15 generates a record signal Sr for recording the superposition information Smx on the optical disk DK by modulating the intensity of the light beam B for recording based on the superposition information Smx, and outputs it to the above semiconductor laser driving portion in the pickup 2.

Thereafter, the semiconductor laser driving portion has the light beam B radiated by driving the semiconductor laser to modulate the intensity of the light beam B according to the contents of the record signal Sr. And the light beam B is radiated to an information recording face in the optical disk DK while the intensity thereof is modulated so that the recording pit changing its shape according to the contents of the record signal Sr is formed in the information recording face, and the music information Sine is thereby recorded in the as-is form (as-is encoding method) as distribution data mentioned later on the optical disk DK.

In this case, the horizontal and vertical positions of the light beam B radiated to the information recording face are controlled by the driving of the focus actuator and tracking actuator in the pickup 2 as in the case of the above-mentioned “(A) Embodiment of recording operation from the external sound source”.

Furthermore, the spindle motor 1 controls the revolutions of the optical disk DK to have the preset number of revolutions based on the control signal Ssm from the servo IC 16 as in the case of the above-mentioned “(A) Embodiment of recording operation from the external sound source”

And for these purposes, the servo IC 16 generates and outputs the above control signals Ssm and Ssp based on the control signal Sss from the system controller 8 respectively.

If the music information Sine distributed from the distribution server by the above-mentioned series of recording processes is recorded as the distribution data in the as-is form and by the as-is encoding method on the optical disk DK, then the system controller 8 outputs the control signal Sss for controlling the radiated position of the light beam B to the servo IC 16 in order to reread the distribution data having the recording process completed. Thus, the servo IC 16 controls the radiated position of the light beam B in order to reproduce the distribution data just recorded based on the control signal Sss. Moreover, in parallel with this process of the system controller 8, the switch 11c in the formatter 11 is switched to the decoder 10 side based on the control signal Ssf.

And the pickup 2 receives the reflected light of the light beam B of which radiated position is controlled from the optical disk DK, and generates the above detection signal Spp corresponding to the contents of the recorded distribution data and outputs it to the demodulating portion 3.

Thus, the demodulating portion 3 performs a preset demodulation process to the detection signal Spp and generates a demodulation signal Sp, and temporarily accumulates it in the memory 14 via the switches 4 and 6 which are switched in the above-mentioned aspects.

On the other hand, the navigation information generator 8a reads as a memory signal 5 mm and analyzes the contents of the accumulated demodulation signal Sp. And based on the analyzed contents, the navigation information generator 8a records the music information in the demodulation signal Sp on the optical disk DK, and then, of the control information (navigation information) for controlling the reproduction aspects of the music information in the demodulation signal Sp after being recorded on the optical disk DK, it generates the information to be superposed on the music information and simultaneously recorded by conforming it to a format mentioned later, and outputs it as the control information Snv to the record data generator 11a.

On the other hand, the memory 14 reads the accumulated demodulation signal Sp in parallel with the generation process of the control information by the navigation information generator 8a, and outputs it to the decoder 10.

And the decoder 10 decodes the demodulation signal Sp, and further converts a recording format of the music information included in the decoded demodulation signal Sp into the recording format of a recording format method decodable by a plurality of types of mutually different information reproducing apparatuses (to be more specific, the recording format of the so-called linear PCM (Pulse Code Modulation) method for instance), and outputs it as a conversion signal Sdc to the switch 11c switched to the decoder 10 side.

Next, the switch 11c outputs the conversion signal Sdc as the music information Ssw to the other input terminal of the switch 11b.

Thus, the switch 11b switched to the switch 11c side outputs the music information Ssw as-is as the music information Srr to the record data generator 11a.

Thus, the record data generator 11a superposes the mentioned music information Srr and the control information Snv to conform to the format mentioned later, and outputs it as the superposition information Smx to the modulating portion 15.

And the modulating portion 15 generates a record signal Sr for recording the superposition information Smx on the optical disk DK by modulating the intensity of the light beam B for recording based on the superposition information Smx, and outputs it to the unshown semiconductor laser driving portion in the pickup 2.

Thereafter, the semiconductor laser driving portion has the light beam B radiated by driving the semiconductor laser to modulate the intensity of the light beam B according to the contents of the record signal Sr. And the light beam B is radiated to an information recording face in the optical disk DK while the intensity thereof is modulated so that the recording pit changing its shape according to the contents of the record signal Sr is formed in the information recording face, and the music information of the contents having converted the format of the distribution data previously recorded is thereby recorded as conversion data mentioned later on the optical disk DK.

In this case, the horizontal and vertical positions of the light beam B radiated to the above information recording face are controlled by the driving of the focus actuator and tracking actuator in the pickup 2 as in the case of the above-mentioned recording of the distribution data.

Moreover, of the conversion data and distribution data recorded on the optical disk DK by the above-mentioned series of operations, it is the music information recorded as the conversion data that is actually reproduced as the music information by the plurality of types of information reproducing apparatuses, and the distribution data is used when moving the music information to the secondary receiving source.

Next, a description will be given as to the operation in the case of moving the distribution data recorded on the optical disk DK by the above-mentioned series of operations to the secondary receiving source.

Moreover, in this case, the switch 4 is switched to the switch 6 side based on the control signal Ssc1 from the system controller 8, and furthermore, the switch 6 is switched to the system interface 9 side based on the control signal Ssc from the system controller 8.

In the case of performing the move process, first, the spindle motor 1 controls the revolutions of the optical disk DK to have the preset number of revolutions based on the control signal Ssm from the servo IC 16.

And the light beam B of a fixed intensity for reproduction is radiated to the information recording face of the optical disk DK from the unshown semiconductor laser in the pickup 2. In this case, the vertical and horizontal positions of the light beam B radiated to the information recording face are controlled by driving of the unshown focus actuator and tracking actuator in the pickup 2 based on the control signal Ssp from the servo IC 16 as with recording of the above information.

Moreover, as to the position on the optical disk DK from which the distribution data is to be reproduced, the recording position of the distribution data to be reproduced on the optical disk DK is obtained based on the contents of the control information recorded together with the music information by the above-mentioned recording process, and based on this, the position on the optical disk DK at which the distribution data to be reproduced is recorded is identified.

Next, the light beam B radiated to the above information recording face is modulated by the recording pit formed on the information recording face, and the reflected light thereof is received by the unshown photo-detector in the pickup 2. And the detection signal Spp is generated and outputted to the demodulating portion 3.

And then, the demodulating portion 3 performs the preset demodulation process to the detection signal Spp and generates the demodulation signal Sp, and outputs it to the system interface 9 via the switches 4 and 6.

And the system interface 9 performs the preset interface process to the demodulation signal Sp, and moves it as music information Soute to the secondary receiving source. In this case, the moved distribution data is to be erased or nullified on the optical disk DK.

Next, the above-mentioned series of data recording processes by the EMD will be described by organizing its entirety according to the flowchart shown in FIG. 2.

As shown in FIG. 2, in the data recording processes, it is first checked whether or not the music information obtained by the EMD in the past is recorded in the as-is form as the distribution data on the optical disk DK (step S1), and if the distribution data does not exist (step S1; NO), it moves on as-is to the process in a step S3. On the other hand, if the distribution data distributed in the past has already been recorded (step S1; YES), a recording completion position on the optical disk DK is obtained as to the latest piece of the distribution data distributed in the past (step S2).

Next, the music information is received from the distribution data server as described above, and the received music information is recorded by the above-mentioned series of data recording processes from the head of a recording area of the optical disk DK (in the case of the above step S1; NO) or the position immediately following the recording completion position of the latest piece of the distribution data in the past (in the case of going through the above step S2) (step S3). The area in which the distribution data is recorded is hereafter referred to as a distribution data area.

And while recording the distribution data, it is constantly monitored whether or not it is completed (step S4). If not completed (step S4; NO), it returns to the process in the step S3 to continue the receiving and recording processes. If completed (step S4; YES), the distribution data once recorded is read again to be decoded by the decoder 10 next (step S5), and its recording format is converted to the linear PCM method for instance (step S6). And the music information after the conversion is recorded as conversion data in a conversion data area ARO on the optical disk DK mentioned later (step S7). In this case, of the above control information, the information to be superposed in the conversion data and recorded is recorded concurrently with the recording of the conversion data.

And during the recording of the conversion data, it is constantly monitored whether or not it is completed (step S8). If not completed (step S8; NO), it returns to the process in the step S5 to continue the decoding and converting processes. If completed (step S8; YES), of the control information, the information to be recorded separately from the conversion data is recorded in a format mentioned later to correspond to the recorded conversion data (including the recording completion position obtained by the process in the step S2) (step S9) so as to finish the series of data recording processes.

(D) Embodiment of the Recording Format

Next, a description will be given as to the recording format used when recording the distribution data and conversion data by the operation described by using FIGS. 1 and 2.

First, the physical format showing physical data structure on the optical disk DK will be described by using FIGS. 3 and 4.

As shown in the upper diagram in FIG. 3, the optical disk DK having the conversion data and distribution data recorded thereon has a formation therein of, from its inner radius side, a lead-in area LI having the control information (including the address information indicating the head of the area on the optical disk DK having the music information recorded therein and so on) to be read when starting reproduction of the music information recorded on the optical disk DK, a file information area FIA having file information indicating the hierarchy of the music information recorded as the distribution data and conversion data and so on, a file area FA having the distribution data and conversion data actually recorded therein, and a lead-out area LO having the control information (including the address information indicating the end of the area on the optical disk DK having the music information recorded therein and so on) to be read when finishing the reproduction of the music information recorded therein.

And the file area FA has a formation therein of a control information area IFO having the control information (except the control information included in the conversion data) stored therein, the conversion data area ARO having the conversion data recorded therein together with the control information included in the conversion data, a distribution data area EMD having only the distribution data stored therein, and a control information backup information area BUP having the same control information as the control information stored in the control information area IFO as so-called backup (preliminary) information stored therein.

Here, in the conversion data area ARO, a piece of music information is comprised of one program or a plurality of programs and recorded, and furthermore, one program is comprised of one cell or a plurality of cells and recorded as mentioned above.

Next, change in the recording aspect of the data recorded in each area shown in FIG. 3 will be described while illustrating it by using FIG. 4. FIG. 4 illustrates the case where a piece of conversion data and the distribution data corresponding thereto are recorded together with corresponding control information first, and then the music information from the external sound source other than the distribution server is recorded as the conversion data by the linear PCM method together with the corresponding control information. Thereafter, it further illustrates the case where other conversion data and the distribution data corresponding thereto are recorded together with corresponding control information again. Here, each piece of conversion data is comprised of one program comprised of one cell respectively.

First, immediately after a piece of conversion data and the distribution data corresponding thereto are recorded together with the corresponding control information, as shown in FIG. 4A, first distribution data ED1 is stored as the one piece of distribution data in the distribution data area EMD on the optical disk DK, and furthermore, first conversion data RD1 obtained by converting it is stored as the above one piece of conversion data in the conversion data area ARO.

And control information MG as the control information corresponding to this is recorded by having the hierarchy mutually formed by first program information PG1 indicating the number of the cells included in one program constituting the first conversion data RD1 and first cell information C1 including the address information (indicating an offset logical address from the head of the conversion data area ARO, and the same hereafter) indicating a recording start position on the optical disk DK of one cell constituting the one program.

Next, immediately after the music information outputted from an external CD (Compact Disc) reproducing apparatus for instance is recorded as-is by the linear PCM method together with the corresponding control information after the first distribution data ED1 and the first conversion data RD1 are recorded, second conversion data RD2 equivalent to the music information is stored in the conversion data area ARO as shown in FIG. 4B. The second conversion data RD2 in this case is substantially the music information inputted from the external CD reproducing apparatus or the like recorded as-is by the linear PCM method.

And control information MG′ as the control information corresponding to this is recorded by having the hierarchy mutually formed by second program information PG2 indicating the number of the cells included in one program constituting the second conversion data RD2 and second cell information C2 including the address information indicating the recording start position on the optical disk DK of one cell constituting the one program.

And lastly, immediately after the other conversion data and the distribution data corresponding thereto are recorded again together with the corresponding control information after the second conversion data RD2 is recorded, as shown in FIG. 4C, second distribution data ED2 is stored as the other distribution data in the distribution data area EMD on the optical disk DK, and furthermore, third conversion data RD3 obtained by converting it is stored as the above other conversion data in the conversion data area ARO.

And control information MG″ as the control information corresponding to this is recorded by having the hierarchy mutually formed by third program information PG3 indicating the number of the cells included in one program constituting the third conversion data RD3 and third cell information C3 including the address information indicating the recording start position on the optical disk DK of one cell constituting the one program and so on.

In the example described by using FIG. 4, the address information of the conversion data in the conversion data area ARO is “00000000h (h indicates a hexadecimal, and the same hereafter),” “11111111h” and “22222222h” in order from the first conversion data RD1 for instance. Furthermore, the address information of the distribution data in the distribution data area EMD (in this case, the offset logical address from the head of the distribution data area EMD) is “00000000h” and “00001111h” in order from the first distribution data ED1 for instance.

Next, the logical format in the above control information will be described in further detail by using FIG. 5 and taking the control information MG″ in FIG. 4C as an example.

The control information MG″ including the control information corresponding to the first conversion data RD1 to the third conversion data RD3 respectively is comprised of comprehensive information 21, a file information table 22, program chain information 23, and other information 24 required for the control information MG″ as shown in FIG. 5.

In this case, the comprehensive information 21 includes the information on the entire optical disk DK having up to the third conversion data RD3 recorded thereon, to be more specific, the numbers of pieces of conversion data and the distribution data recorded at that time respectively, the start positions on the optical disk DK of the conversion data area ARO and the distribution data area EMD respectively and so on.

Next, as mentioned later, the file information table 22 includes an attribute of the conversion data (that is, whether or not it is the conversion data converted from the distribution data) and the recording start position on the optical disk DK of the conversion data.

Furthermore, the program chain information 23 includes the above program information and cell information.

Next, the program chain information 23 will be described more concretely.

As shown in FIG. 5, the program chain information 23 in the control information MG″ includes comprehensive information 25, the above first program information PG1 to third program information PG3, a first cell search pointer 27-1 to a third cell search pointer 27-3 indicating the positions on the optical disk DK at which the above first cell information C1 to third cell information C3 are recorded respectively, and the above first cell information C1 to third cell information C3.

A piece of cell information (the first cell information C1 for instance) is comprised of comprehensive information 29 and other information 30 which is the other information required for the cell information.

And the comprehensive information 29 includes attribute information 31 indicating the attribute of the conversion data including the cell corresponding to the comprehensive information 29, conversion data search pointer number information 32 which is the number of the conversion data search pointer mentioned later corresponding to the conversion data including the cell corresponding to the cell information including the comprehensive information 29, and other information 33 which is the other information required for the comprehensive information 29. Here, the conversion data search pointer number information 32 is included in the comprehensive information 29, and so it is possible to associate the cell information including the comprehensive information 29 with the conversion data.

The attribute information 31 indicates whether or not the conversion data including the cell is the conversion data converted from the distribution data by the contents of the highest order bit thereof, and further indicates whether or not the cell is the cell as the music information according to the contents of the 2 low order bits thereof.

To be more specific, if the highest order bit of the attribute information 31 is “1” for instance, it indicates that the conversion data including the cell is the data converted from the distribution data, and if the highest order bit is “0”, it indicates that the conversion data including the cell is not the data converted from the distribution data, that is, to be more specific, it is the music information of the linear PCM method reproduced by the CD reproducing apparatus, for instance. Furthermore, if the 2 low order bits of the attribute information 31 is “10,” it indicates that the cell is the cell as the music information.

Next, the file information table 22 will be described more concretely.

The file information table 22 includes comprehensive information 34 including the conversion data information mentioned later and the information indicating the numbers of the conversion data search pointers respectively and so on, first conversion data information 36-1 including the recording position information and so on, on the first conversion data RD1, second conversion data information 36-2 including recording position information and so on, on the second conversion data RD2, third conversion data information 36-3 including recording position information and so on, on the third conversion data RD3, and a first conversion data search pointer 35-1 to a third conversion data search pointer 35-3 indicating the positions on the optical disk DK at which the first conversion data information 36-1 to third conversion data information 36-3 are recorded respectively.

Each piece of the conversion data information includes comprehensive information 37 and a conversion data unit information table 38.

And the comprehensive information 37 includes therein conversion data attribute information (having the same contents as those of the above corresponding attribute information 31) 39 indicating the attribute of the corresponding conversion data and other information 40 which is the other information required for the comprehensive information 37.

Furthermore, the conversion data unit information table 38 includes therein comprehensive information 41 and conversion data unit information 42 indicating an amount of information as to each piece of information constituting the corresponding conversion data.

And the comprehensive information 41 includes conversion data start address information 43 which is the address information in the conversion data area ARO of the corresponding conversion data, distribution data start address information 44 which is the address information in the distribution data area EMD of the distribution data being a conversion source of the conversion data, and other information 45 which is the other information required for the comprehensive information 41.

Here, the contents of the above distribution data start address information 44 will be described further in detail. When the corresponding conversion data is the data obtained by converting the distribution data (that is, when the highest order bit of the attribute information 31 is “1” in the above example), the distribution data start address information 44 has the address information corresponding to the distribution data which is the conversion source thereof described therein as mentioned above. When the corresponding conversion data is not the data obtained by converting the distribution data (that is, when the highest order bit of the attribute information 31 is “0” in the above example), the distribution data which is the conversion source does not exist in the first place, and so the information which is originally invalid as the distribution data start address information 44 (“FFFFFFFFh” for instance) is described.

In a step S9 in the data recording process shown in the above FIG. 2, the distribution data start address information 44 generated in a state where the distribution data already exists (FIG. 2 step S1; YES) has end position information on the latest piece of the past distribution data obtained in the process of the step S2 in the FIG. 2 described therein.

(E) Embodiment of the Data Moving Process

Lastly, a series of data moving processes (that is, the instance of the move in the case of the above mentioned check out) conforming to the SDMI specifications performed centering on the system controller 8 will be described by using the flowchart in FIG. 6.

As shown in FIG. 6, in the data moving process in the embodiment, the system controller 8 checks whether or not the operation for performing the data moving process was implemented by an operating portion not shown in FIG. 1 (step S10). If not implemented (step S10; NO), it stands by until the process is implemented, and if implemented (step S10; YES), it then checks the attribute information 31 corresponding to the data to be moved and thereby determines whether or not the cell to which the attribute information 31 is corresponding (in other words, the corresponding conversion data including that cell) is the cell (conversion data) obtained by converting the distribution data (step S11). And if the cell is not the cell (conversion data) obtained by converting the distribution data (step S11; NO), it is impossible to perform the data moving process shown in FIG. 6 because no corresponding distribution data exists, so that an error display to that effect is performed on a display not shown (step S18) so as to finish the data moving process itself. If the cell is the cell (conversion data) obtained by converting the distribution data (step S11; YES), it then obtains a program number indicating the program to be moved (step S12), and further obtains corresponding program information PG by using the program number as a clue (step S13), further obtains corresponding cell information C by using the program information PG as a clue (step S14), obtains the number of the conversion data which the cell belongs to according to the contents of the conversion data search pointer number information 32 (see FIG. 5) included in the comprehensive information 29 in the cell information C (step S15), and further obtains the distribution data start address information 44 of the distribution data described in the conversion data information corresponding to the conversion data of the obtained number (step S16).

And it determines whether or not the contents of the obtained distribution data start address information 44 are “FFFFFFFFh” (step S17). If the contents thereof are “FFFFFFFFh,” that is, an invalid value (step S17; YES), it is impossible to perform the data moving process shown in FIG. 6 because no corresponding distribution data exists, so that it undergoes the above-mentioned error process in the step S18 so as to finish the data moving process itself.

If the contents of the distribution data start address information 44 are a value other than “FFFFFFFFh,” that is, a valid address information in the determination in the step S16 (step S17; NO), it then obtains that address information (step S19), and reads the distribution data recorded in the distribution data area EMD headed by the address indicated by the obtained address information and moves it to as the music information Soute to the secondary receiving source (step S20).

And it checks whether or not the moving process of the distribution data was completed (step S21), and if not completed (step S21; NO), it continues the process. If completed (step S21; YES), it erases or nullifies the distribution data to be moved in the optical disk DK (step S22), and further erases or nullifies the conversion data recorded in the conversion data area ARO by converting the distribution data to be moved (step S23), and updates the contents of the control information corresponding to the erased distribution data and conversion data (step S24) so as to finish a series of the data moving processes.

To describe the process in the above step S24 concretely, of the conversion data information 36 in the above control information, it deletes the conversion data information 36 corresponding to the distribution data and conversion data erased or nullified in the above steps S22 and S23 respectively together with the conversion data start address information 43 (corresponding to the conversion data erased or nullified in the steps S23) and distribution data start address information 44 (corresponding to the distribution data erased or nullified in the steps S22) included therein.

As described above, according to the operation of the information recording apparatus S related to the embodiments, it records the distributed music information by converting it into the linear PCM method so that distributed record information can be recorded in a state capable of decoding and reproduction by a plurality of types of information reproducing apparatuses so that the compatibility in the reproduction process can be secured.

At least when the music information recorded after the distribution is determined as undetectable on the optical disk DK, the conversion data start address information 43 and distribution data start address information 44 corresponding to the music information determined to be undetectable are deleted on the optical disk DK, and so even if an attempt is made to illegally render detectable by an operation after the deletion the music information determined to be undetectable, the illegal operation can be rendered infeasible since both the conversion data start address information 43 and distribution data start address information 44 have disappeared.

Furthermore, the address information is deleted after the distributed music information is moved, and it is thus possible to securely prevent the distributed music information from being illegally restored on the optical disk DK after the moving process.

Furthermore, when recording the music information other than the distributed music information on the optical disk DK, the information indicating that the distribution data start address information 44 is invalid (“FFFFFFFFh” for instance) is recorded on the position at which the distribution data start address information 44 should be recorded, and it is thus possible to record the other music information while maintaining the compatibility on the recording format with the case of recording the distributed music information.

It is also possible to implement the recording process and so on as to the music information while observing the rules for moving the distributed music information stipulated in the SDMI specifications.

In the above-mentioned embodiments, the cases of checking out or moving the distribution data recorded on the optical disk DK were described. In addition, it is also possible to apply the present invention to the case where, in the instance of moving the conversion data generated after the distribution rather than the distribution data itself to another reproducing apparatus and so on, the distribution data remaining on the original optical disk DK is deleted therefrom in compliance with the above SDMI specifications. Also in this case, after deleting the distribution data, it deletes the conversion data information 36 which is corresponding to the (moved) conversion data corresponding to the distribution data and the distribution data itself respectively on the optical disk DK together with the distribution data start address information 44 and conversion data start address information 43 included therein.

Furthermore, the present invention is also applicable to the case of merely deleting rather than checking out or moving at least one of the distribution data and conversion data on the optical disk DK. Also in this case, after deleting at least one of the distribution data and conversion data, it deletes the conversion data information 36 corresponding to one of them on the optical disk DK together with the distribution data start address information 44 and conversion data start address information 43 included therein. And also in this case, as with the above embodiments, if the attempt is made to illegally render the deleted distribution data or conversion data detectable by the subsequent operation, the illegal operation can be rendered infeasible.

In the above embodiments, the cases of temporarily recording the distribution data on the optical disk DK and then rereading it to generate the conversion data were described. In addition, it is also possible to record the distribution data on the optical disk DK and convert the distribution data into the conversion data in parallel by using the distributed distribution data in a branching fashion and to record the distribution data itself on the optical disk DK and record the conversion data on the optical disk DK in parallel.

Furthermore, it is also possible to record a program corresponding to the flowcharts shown in the above FIGS. 2 and 6 on a flexible disk, a hard disk or the like or to distribute and/or record it via a network such as the Internet and have it read and run by a general-purpose microcomputer for instance so as to have the microcomputer function as the system controller 8 of the embodiments.

Furthermore, while the above-mentioned embodiments described the cases of recording the music information on the optical disk DK, the present invention is also applicable to the cases of securing the compatibility when recording video information including the corresponding music information on the optical disk DK.

Furthermore, the present invention is also applicable to the cases of using a hard disk or a semiconductor memory as the recording medium in addition to the optical disk DK.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2002-3524 filed on Jan. 10, 2002 including the specification, claims, drawings and summary is incorporated herein by reference in its entirety.

What is claimed is:

1. An information recording apparatus comprising:
an encoding device which encodes record information in a specific encoding scheme for allowing decode by a plurality of types of information reproducing apparatuses to generate encoded record information;
a first recording device which records the generated encoded record information on a recording medium;
a second recording device which records the record information as-is in an original encoding scheme thereof on the recording medium;
an address information recording device which records record address information including first address information indicating a position on the recording medium where the generated encoded record information is recorded and second address information indicating a position on the recording medium where the record information is recorded as-is in the original encoding scheme thereof; and
a deleting device which, at least when the record information recorded as-is in the original encoding scheme thereof is determined to be undetectable on the recording medium, deletes from the recording medium the record address information corresponding to the record information determined to be undetectable.

2. The information recording apparatus according to claim 1, wherein, the record information is determined to be undetectable on the recording medium in the case where a process of deleting the record information from the recording medium is performed or a process of moving the record information from the recording medium to the outside is performed.

3. The information recording apparatus according to claim 1, wherein, in the case where the record information is one other than record information distributed via a network, the address information recording device records invalidity information, indicating that the second address information is invalid, at the position on the recording medium at which the second address information should be recorded.

4. The information recording apparatus according to claim 1, wherein the record information is distributed via a network in compliance with the SDMI (Secure Digital Music Initiative) specifications.

5. An information recording method comprising:
an encoding process of encoding record information in a specific encoding scheme for allowing decode by a plurality of types of information reproducing apparatuses to generate encoded record information;
a first recording process of recording the generated encoded record information on a recording medium;
a second recording process of recording the record information as-is in an original encoding scheme thereof on the recording medium;
an address information recording process of recording record address information including first address information indicating a position on the recording medium where the generated encoded record information is recorded and second address information indicating a position on the recording medium where the record information is recorded as-is in the original encoding scheme thereof; and
a deleting process of, at least when the record information recorded as-is in the original encoding scheme thereof is determined to be undetectable from the recording medium, deletes from the recording medium the record address information corresponding to the information determined to be undetectable.

6. A program embodied in a recording medium which can be read by a computer in an information recording apparatus, the program causing the computer to function as:
an encoding device which encodes record information in a specific encoding scheme for allowing decode by a plurality of types of information reproducing apparatuses to generate encoded record information;
a first recording device which records the generated encoded record information on a recording medium;
a second recording device which records the record information as-is in an original encoding scheme thereof on the recording medium;
an address information recording device which records record address information including first address information indicating a position on the recording medium where the generated encoded record information is recorded and second address information indicating a position on the recording medium where the record information is recorded as-is in the original encoding scheme thereof; and
a deleting device which, at least when the record information recorded as-is in the original encoding scheme thereof is determined to be undetectable on the recording medium, deletes from the recording medium the record address information corresponding to the record information determined to be undetectable.
